(19) United States
(12) Patent Application Publication
(10) Pub. No.: US 2016/0300378 A1
(43) Pub. Date: Oct. 13, 2016

(54) A METHOD AND SYSTEM FOR RECORDING VEHICLE DATA

(71) Applicant: JAGUAR LAND ROVER LIMITED, Coventry, Warwickshire (GB)

(72) Inventors: Peter Thomas, Coventry, Warwickshire (GB); Paul Youdan, Coventry, Warwickshire (GB); Leon Hurst, Coventry, Warwickshire (GB); Damian Dinning, Coventry, Warwickshire (GB)

(21) Appl. No.: 15/037,491

(22) PCT Filed: Dec. 17, 2014
(86) PCT No.: PCT/EP2014/078304

§ 371 Date: May 18, 2016

(30) Foreign Application Priority Data
Dec. 17, 2013 (GB) 1322337.5

(51) Int. Cl. G06T 13/20; G07C 5/06; G07C 5/00; H04N 5/765

(52) U.S. Cl. CPC G06T 13/20; H04N 5/765; G07C 5/06; G07C 5/008

(57) ABSTRACT

A method of representing a vehicle journey to a user, the method comprising: recording vehicle data over time for a vehicle journey; processing the recorded vehicle data in order to generate an animation of the vehicle journey, the animation of the vehicle journey comprising an animation of the vehicle; displaying at least part of the generated animation to the user.

### TECHNICAL FIELD

The present disclosure relates to a method and system for recording vehicle data. In particular, but not exclusively, the present disclosure relates to a method of representing a vehicle journey from recorded vehicle data. Aspects of the invention relate to a method, to a system and to a vehicle.

### BACKGROUND

Modern vehicles are provided with a wide array of in-built sensor technology. Additionally many modern vehicles are also provided with the capability to send and receive communications traffic, for example via docking connectors (e.g. USB, micro-USB etc.) and wireless connection technology (e.g. Bluetooth®, Wifi etc.).

It is an object of the present invention to provide a method of utilising the available sensor technology to enable interaction with and analysis of a vehicle journey after the journey has ended.

### SUMMARY OF THE INVENTION

According to one aspect of the present invention there is provided a method of representing a vehicle journey to a user, the method comprising: recording vehicle data over time for a vehicle journey; processing the recorded vehicle data in order to generate an animation of the vehicle journey; displaying at least part of the generated animation to the user. The animation of the vehicle journey may comprise an animation of the vehicle

Conveniently, vehicle data may be recorded from one or more vehicle sensors. Vehicle data may be supplied from a vehicle communication network, e.g. from a vehicle multiplexed database or from a CAN, Flexray or Ethernet bus.

Sensor outputs may comprise one or more of the following: Front Right wheel speed; Front Left wheel speed; Rear Right wheel speed; Rear Left wheel speed; Steering angle; Front Right ride height; Front Left ride height; Rear Right ride height; Rear Left ride height; vehicle lateral acceleration; vehicle longitudinal acceleration; vehicle yaw rate/acceleration; differential lock status; differential locking torque; damper stiffness; engine revs; gear position; Vehicle ground speed; terrain type; terrain roll; terrain pitch; vehicle yaw angle; vehicle Roll angle; vehicle Pitch angle; Direction of travel; Latitude of vehicle; Longitude of vehicle; altitude of vehicle (height above sea level).

The animation of the vehicle journey may comprise an animation of the environment the vehicle has travelled through during the course of the vehicle journey. Generation of the animation of the environment may be performed in dependence on the vehicle data. The vehicle data may be used to recreate the terrain the vehicle has traversed during at least part of the vehicle journey.

The generated animation may comprise a recreation of the terrain the vehicle has traversed during at least part of the vehicle journey. The recreation of the terrain may be performed in dependence on at least one colour sampled from video footage of the vehicle's surroundings during the vehicle journey.

The terrain may comprise one or more of: road surface, road direction, road roughness, ground surface, ground roughness, ground type.

The recreation of the terrain the vehicle has traversed during at least part of the vehicle journey may be generated in dependence on at least one sensor output.

The animation of the vehicle may comprise an animation of at least one vehicle sub-system. The method may comprise indicating that the at least one vehicle sub-system is activated and/or indicating an operational state of the at least one vehicle sub-system. The at least one vehicle sub-system may be highlighted to the user.

The animation of the animated vehicle may be made partially transparent in order to show the animation of the at least one vehicle sub-system.

The at least one vehicle sub-system to be animated may be user selectable.

The at least one vehicle sub-system may comprise one or more of: Terrain Response; Active Dynamics; Electronic cross linked air suspension with variable ride height; Hill Descent Control; Active/Passive rear and centre diff; Torque Vectoring by Braking; Active Dynamics/Continuously Variable Damping (CVD); Active Exhaust; Launch Mode; Electronic Differential; Active Driveline; Wade sensing; Tyre Pressure Monitoring System. Additionally or alternatively, vehicle data may be supplied from an external sensor. For example, the external sensor may be comprised within a mobile communications device or any other suitable consumer electronics device. The mobile telecommunications device may comprise a smartphone running a software app (e.g. a telematics software app), the smartphone being in communication with a vehicle electronic control unit via a communications link. Conveniently, the mobile device may interact with the vehicle systems by means of a suitable wireless communications, such as short range wireless connection, e.g. a Bluetooth® link. Alternatively the mobile device may interact via a wired link, e.g. a USB connection.

Conveniently, the animation may provide a virtual point of view option allowing the animation to be replayed from any desired viewpoint.

The method may comprise analyzing the received vehicle data to determine sections of the journey that conform to predetermined driving parameters. The driving parameters may comprise parameters indicative of driving conditions close to or exceeding a vehicle adherence condition. For example, driving parameters may comprise vehicle acceleration rate or engine revs. It is noted that vehicle acceleration may comprise linear acceleration parallel with any of the vehicle axes (longitudinal, and lateral axes) and angular acceleration in roll, pitch or yaw.

With reference to vehicle adherence conditions it is noted that a vehicle may exceed an adherence condition where the wheels lose traction and start spinning.

Alternative driving parameters that may be analysed comprise may comprise large slope angles, high levels of acceleration, large amounts of suspension articulation / wheel(s) off the ground.

Sections of the vehicle journey that conform to the predetermined driving parameters may be displayed to the user. In this way the user may “filter” their journey to highlight specific driving conditions/incidents.

Vehicle data received from one or more vehicle sensors may additionally be checked against sections of the journey that conform to predetermined driving parameters to identify any faults in vehicle sub-systems. For example, excessive braking conditions would be expected to result in the activation of an ABS system. Vehicle data from an accelerometer could be analysed to determine sections of the journey which should have triggered the ABS system. The ABS activation log may then be cross checked with the analysed vehicle data to determine if it activated as expected, an error flag being raised in the event that the vehicle sub-system did not activate correctly.

Conveniently, for sections of the journey that conform to predetermined driving parameters, the method may further comprise: checking if a given section comprises vehicle driving parameters that would trigger a vehicle safety system; checking the identified vehicle safety system during the time period associated with the given section; identifying a fault condition if the identified vehicle safety system was not active during the given section.

Vehicle data may be recorded for a complete vehicle journey between key cycle/ignition events. Alternatively, vehicle data may only be recorded for part of a vehicle journey occurring between ignition events. Vehicle data may also be recorded in response to a user activated control signal.

The recorded vehicle data may conveniently comprise video footage of the vehicle's surroundings during the vehicle journey and the generated animation may comprise an animated representation of the vehicle combined with the recorded video footage.

According to another aspect of the present invention there is provided a method of determining faults in a vehicle sub-system, the method comprising: recording vehicle data over time for a vehicle journey, the vehicle data comprising one or more vehicle driving parameters; identifying portions of the vehicle journey where one or more vehicle driving parameters exceed an activation threshold for the given vehicle sub-system; checking the vehicle sub-system during the identified portions of the vehicle journey; identifying a fault condition with the vehicle sub-system in the event that the vehicle sub-system did not activate during the identified portions of the vehicle journey.

The vehicle sub system may comprise a traction control system or an anti-lock braking system.

According to another aspect of the present invention, there is provided a system for representing a vehicle journey to a user, the system comprising: means for recording vehicle data over time for a vehicle journey; and processing means for processing the recorded vehicle data in order to generate an animation of the vehicle journey. The animation of the vehicle journey may comprise an animation of the vehicle.

The system may comprise display means for displaying at least part of the generated animation to the user.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a typical configuration for a vehicle;

FIG. 2 shows an overview of a user's interaction with a system according to an embodiment of the present invention;

FIG. 3 shows an overview of the data capture process according to an embodiment of the present invention;

FIGS. 4 to 6 show examples of user interfaces in accordance with an embodiment of the present invention.

### DETAILED DESCRIPTION

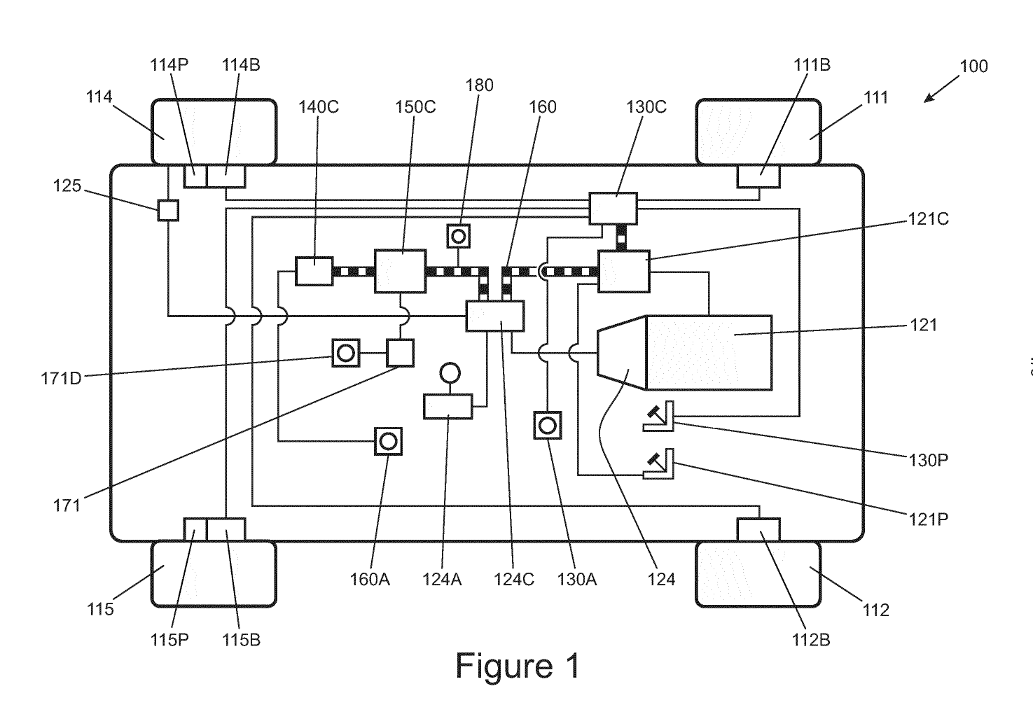

FIG. 1 shows a typical configuration for a vehicle 100. As shown in FIG. 1 the vehicle 100 comprises an internal combustion engine 121, an automatic transmission 124 and a set of four wheels 111, 112, 114, 115. Each of the wheels has a respective disc brake 111B, 112B, 114B, 115B operable by means of a driver operated brake pedal 130P to decelerate the vehicle when the vehicle is moving. Rear wheels 114, 115 of the vehicle are also provided with a respective driver operated parking brake 114P, 115P each in the form of a drum brake. The parking brakes 114P, 115P are operable to be applied and released by means of a driver-operated parking brake actuator 130A in the form of a push-button actuator. A driver operated accelerator pedal 121P allows the engine 121 to be operated to accelerate the vehicle when the vehicle is moving.

The vehicle 100 has a body controller (BCM) 140C, an engine controller 121C, a brake controller 130C, a transmission controller 124C and a restraint controller 150C. The controllers 140C, 121C, 130C, 124C, 150C are arranged to communicate with one another by means of a controller area network (CAN) bus 160. In an alternative arrangement the vehicle may comprise other networking arrangements to allow communication between various on-board components. Other networking arrangements may comprise an Ethernet arrangement or a Flexray communications bus.

The body controller 140C is arranged to detect the status of a drivers door of the vehicle by means of a door sensor 160A and the state of a bonnet (or hood) of the vehicle 100.

The engine 121 is operable to be started and stopped by means of the engine controller 121C.

The brake controller 130C is operable to apply the parking brakes or disc brakes according to signals received from the brake pedal 130P and parking brake actuator 130A, respectively.

The transmission controller 124C is operable to control the transmission 124 in order to connect and disconnect the transmission 124 from the engine 121. The controller 124C is also operable to control the transmission 124 to operate according to one of a plurality of modes of operation. A driver operable actuator 124A is coupled to the transmission controller 124C by means of which the driver may select the required mode.

In the vehicle of FIG. 1 the modes are: (1) a park mode in which the transmission 124 is disconnected from the engine 121 and a park mode pin element 125 is controlled to immobilise the vehicle transmission and any wheel of the vehicle, e.g. a rear wheel 114 of the vehicle, that is connected to the transmission; (2) a reverse mode in which the transmission 124 is arranged to drive the vehicle in a reverse direction; (3) a neutral mode in which the transmission 124 is disengaged from the engine but the park mode pin element 125 is not engaged; (4) a drive mode in which the transmission 124 is engaged with the engine 121 and is operable automatically to select a required one of eight forward gears of the transmission 124; and (5) a low gear mode in which the transmission 124 is operable automatically to select a first or second gear only.

It is to be understood that other numbers of gears are also useful such as five, six, nine or any other suitable number of gears.

It is to be understood that the transmission controller 124C may control the transmission 124 to assume the park mode when required.

It is to be understood that in some vehicle configurations, when the transmission controller 124C controls the transmission 124 to assume the park mode the vehicle 100 is controlled such that a driver-operable transmission mode selector assumes the park mode in addition to the transmission 124 itself assuming the park mode.

In some configurations the transmission mode selector is required to be physically moved in order to assume the park mode. In some alternative embodiments the transmission mode selector is not required to physically move. For example the mode selector may be provided in the form of a ‘soft key’ or a ‘soft rotary control’ or ‘dial’. Since the physical position or state of the selector is not indicative of the selected mode an electronically-controlled indication of the selected mode is provided whereby the selected mode may be determined by the driver.

In the vehicle 100 of FIG. 1 the restraint controller 150C is configured to detect whether or not the drivers seat belt buckle is fastened to a locking device 171D that secures the seat belt buckle thereby to restrain movement of the driver in the event of an impact. Accordingly the controller 150C is also coupled to a seat buckle state detector 171.

As described in more detail below vehicle data is captured in embodiments of the present invention for further analysis and/or for creating an animation of the vehicle journey. Various sensor data may be captured as noted below. For the sake of legibility the sensors listed below are represented generically in FIG. 1 by virtue of sensor 180 which is in communication with the CAN bus 160.

The following sensor data may be collected: wheel speed; steering wheel angle; suspension height; lateral acceleration; longitudinal acceleration; engine speed; brake pressure/force; GNSS (sat nav) position and direction of travel; yaw rate; cabin microphone; camera(s)

Further sensor related data may comprise: engine torque, transmission data (e.g. the selected gear); ABS system status/activity; Stability control system status/activity; Traction control system status/activity; damper setting; odometer reading; differential (centre and rear) status/torque split.

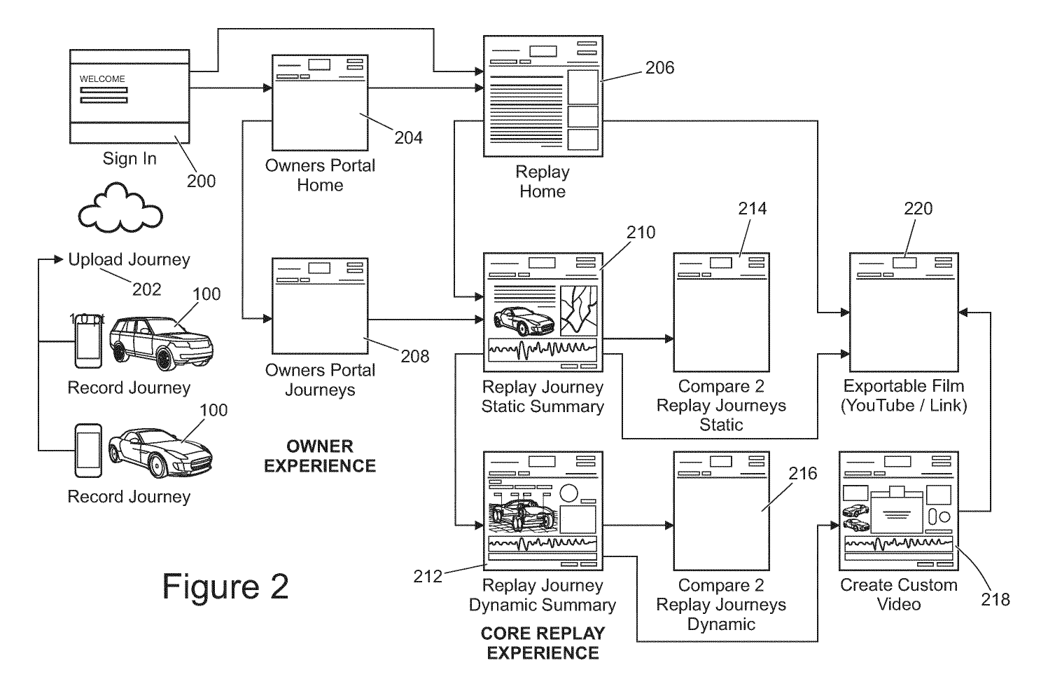

FIG. 2 shows an overview of a user's interaction with a system according to an embodiment of the present invention. The system described below is a telematics based system in which a user may be provided with data from a vehicle journey. The data may be analysed to determine vehicle sub-system usage/operation or used to create an animation of the vehicle journey (in other words the data may be used to “replay” the journey).

In step 200 a user either creates an account for interacting with the system according to the present invention or logs into a previously configured account. Vehicle journeys may be uploaded to the account in step 202. Data uploaded in step 202 may comprise data from a mobile telecommunications device (e.g. a smartphone may upload GPS data, accelerometer data, compass heading data) which has been recorded during a journey. Alternatively, or additionally, CAN data from the vehicle (e.g. from any of the sensors shown in FIG. 1) may be uploaded to the system (it is again noted that the vehicle data may, in an alternative arrangement be uploaded from a Flexray bus, an Ethernet bus or any other suitable communications network).

The user may subsequently interact with the system using either a portal user interface 204 or may move directly to an interface 206 that allows previous journeys to be replayed. It is noted that interface 204 represents a version of the system which is a sub feature of a larger product (e.g. one of a number of telematics features). Interface 206 represents an option where the system according to the invention is a stand-alone system.

The portal interface 204 may provide the user with the option of accessing the user interface 206 or a data upload interface 208 where the journey data from the most recent journey may be uploaded into the system (step 202). The interfaces 206, 208 may be configured to display all available journeys that the vehicle has undertaken. Alternatively, the interfaces may be configured to only display a subset of the available journeys. For example, the vehicle data required to recreate an animated version of a vehicle journey may not be recorded for every journey that the vehicle undertakes. The interfaces may therefore be configured such that only those journeys where the required level of vehicle data is present are displayed.

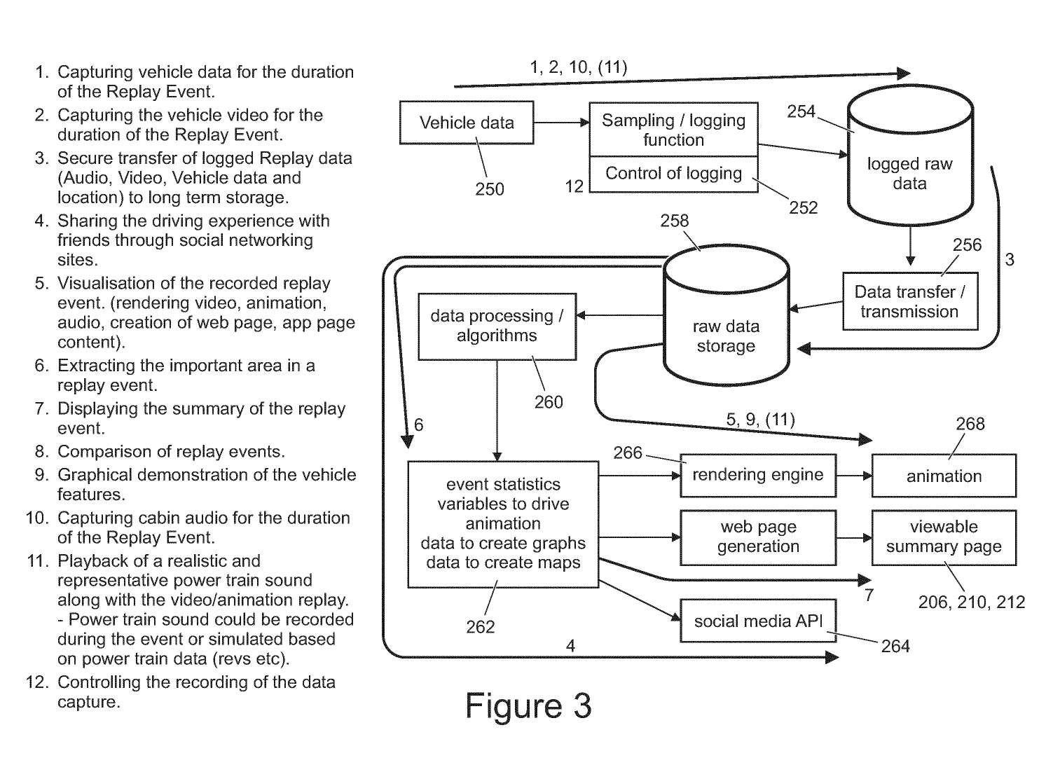

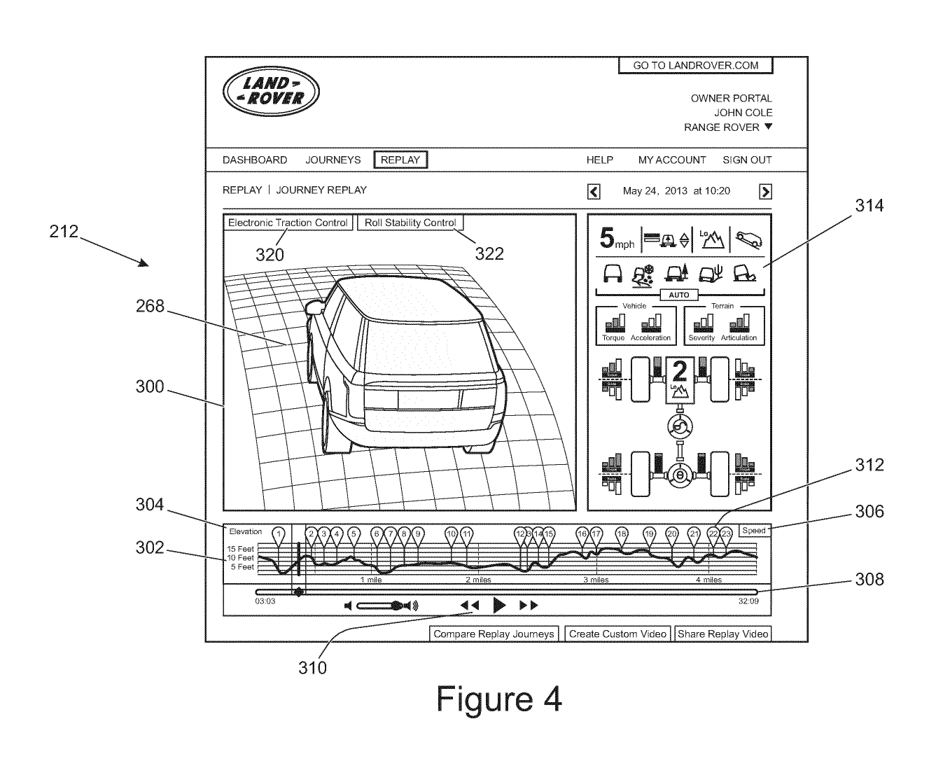

Interfaces 206, 208 allow the user to access a summary overview of their journey (interface 210—see also FIG. 3 below). The journey may also be replayed such that the user can review the performance of the vehicle from the journey (interface 212—see also FIGS. 4 to 6 below).

The user may compare journeys (interfaces 214, 216) and create a video package detailing their journey (interface 218) which may be exported, e.g. to a video hosting service (interface 220).

FIG. 3 shows an overview of the data capture process according to an embodiment of the present invention.

In step 250 vehicle data is generated/recorded by various on-vehicle sensor systems (e.g. accelerometers, yaw sensor, ride height sensor, wheel speed sensors, brake sensors, steering wheel position sensor, audio sensors, parking cameras or other camera sensors etc.).

The vehicle electronic control unit is arranged in step 252 to control the process of sampling and logging the generated vehicle data into a data store 254 of raw data.

The data store 254 may conveniently be on-board the vehicle rather than remote from the vehicle so that vehicle data can be captured without the requirement for a communication link to a remote server. Depending on the type of data being recorded the raw data may in some arrangements be logged in different locations within the vehicle. For example, data recording may be recorded in a gateway module (i.e. a control unit that connects various CAN, Flexray, Ethernet buses together so that data from one bus can be accessed by another bus if needed) whereas video and audio data may be recorded in a vehicle infotainment system.

It is noted that the vehicle data could be constantly recorded when the vehicle is running or the process of data capture may be triggered via a user activated control button so that only specific, user-requested portions of a journey are captured and logged.

In step 256 the logged, raw data stored in the data store 254 may be transferred to a further, long-term data store 258. Data stored in a vehicle's data store 254 may comprise significant memory storage overheads. In order to avoid any issues with storage space within the vehicle the raw sensor data that has been logged by the sensors and stored in the data store 254 may be transferred to a further data store 258. The data store 258 may be remote from the vehicle, e.g. a cloud based storage system, or may be a mobile communications device.

Raw sensor data may be transferred from the data store 254 to a mobile communications device (e.g. a smartphone) via either a wireless link (such as Bluetooth) or a physical connection (e.g. a micro USB connection) within the vehicle. A mobile communications device may also be used to download raw data from the vehicle data store 254 for onward transmission to a remote data store 258.

Following transfer to the data store 258, the vehicle data collected in step 252 may be processed in step 260 to derive processed vehicle data relating to the recorded journey (262). The processed vehicle data may comprise details of sections of the journey that meet specific predefined driving parameters such as acceleration levels, engine rev speeds etc. The raw data in the data store 258 may also be processed to derive variables that may be subsequently used to generate an animation of the vehicle journey.

The processed vehicle data 262 derived in the data processing step 260 may be output in a number of ways. Processed vehicle data may be output via a social media application programming interface 264. Alternatively, processed vehicle data may be output to a web page interface (e.g. interfaces 206, 210, 212). The processed vehicle data 262 may also be output to an animation rendering engine 266 such that an animation 268 of the vehicle journey can be made.

As part of the data processing 260 the system according to an embodiment of the present invention may be configured to extract vehicle driving events in dependence upon predefined driving parameters. Such driving events may then be highlighted to the user via the web page interface or within the animation of the vehicle journey.

Conveniently, the user may be able to search driving events and filter the animation against particular driven event types. For example, one type of driving event may be high acceleration, another type of event may be high braking and a further driving event may be large cornering forces. An animation may be generated so that the vehicle user can “replay” their journey. The user may be presented with the option of watching the entire journey or selecting a particular type of driving event, e.g. high braking events. If a type of driving event is selected then the animation may either highlight such events within the entire animation or may present a “highlights” package in which an abbreviated animation comprising the selected high braking event type only is shown.

FIG. 4 shows an example of a user interface 212 as shown in FIG. 2. The interface 212 comprises an animation window 300 within which an animation 268 of a vehicle journey may be replayed. The interface 212 also comprises an overview window 302 which displays an aspect of the vehicle journey (in this example the vehicle elevation versus distance travelled). The displayed elevation aspect represents a first tab 304 and a second tab 306 is shown which indicates that the user may select an overview interface that shows the vehicle speed versus distance travelled.

A timeline 308 is provided towards the bottom of the overview window 302 and control buttons 310 allow the user to start/pause and scan through the animation of the vehicle journey.

A number of driving event markers 312 are shown in the overview window 302. These markers may be related to particular vehicle driving event types (e.g. events associated with high acceleration, high braking, high cornering forces etc.) and selecting any of these markers 312 may allow the user to skip through the animation 268 to the particular event in question.

A vehicle systems window 314 is also provided in the interface 212 showing the condition of various vehicle sub-systems throughout the course of the vehicle journey.

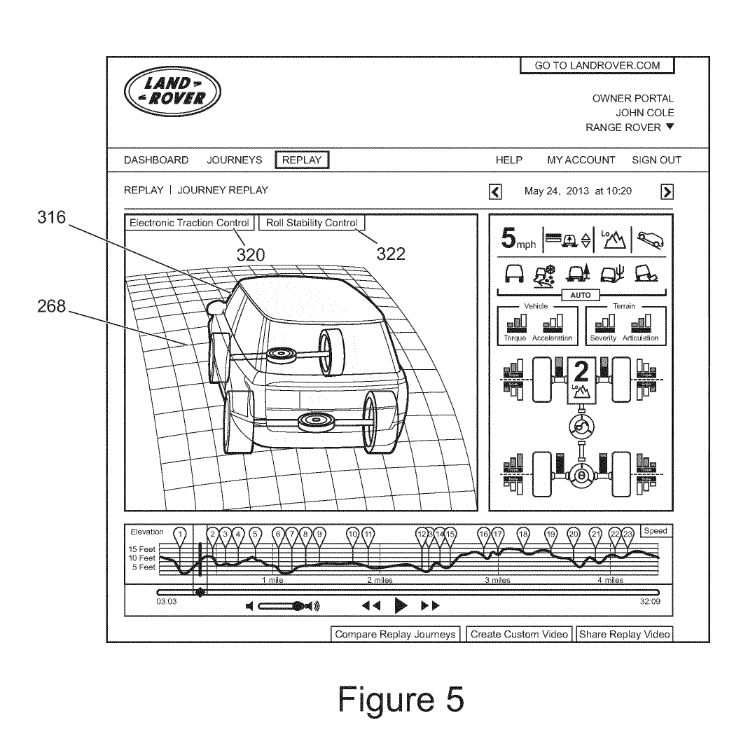

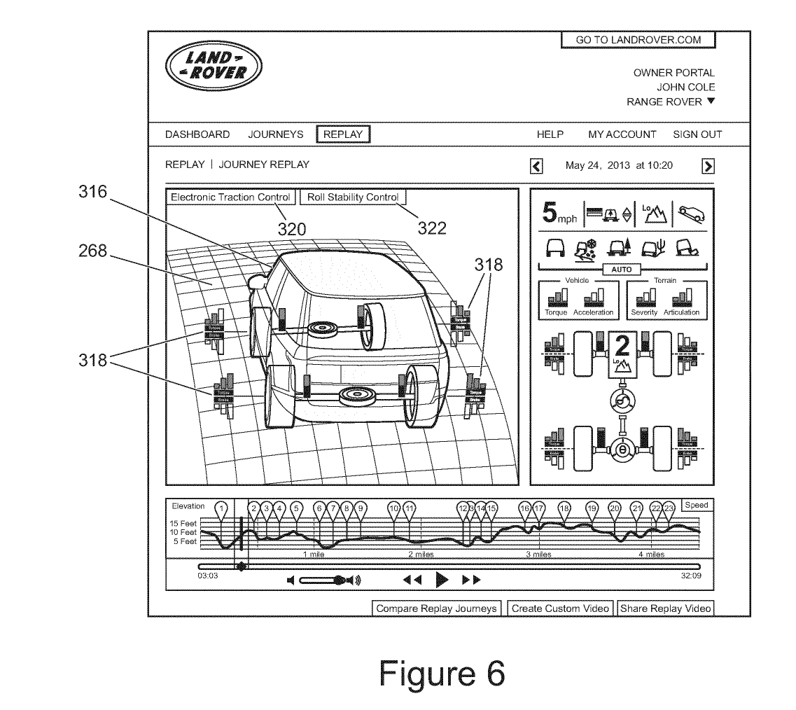

Further user interface examples are shown in FIGS. 5 and 6. In FIG. 5 the animation 268 of the animated vehicle 316 has been made partially transparent in order to show details of vehicle sub-systems that would otherwise be hidden from view.

FIG. 6 is similar to FIG. 5. However, a number of information overlays 318 have been added to the animation 268 in order to highlight, in this example, the torque and braking level at each wheel.

It is also noted that the system may be configured to allow the user to toggle between different user interfaces. For example the menu buttons 320 and 322 located in the upper left corner of animation window 300 may be configured to allow the user to move between the display interfaces of FIGS. 4, 5 and 6. In effect the menu buttons 320, 322 allow the user to turn on the display of various vehicle subsystems.

As noted above the system and method according to the present invention may collect a variety of sensor data. In particular, the following vehicle related sensor outputs (the “vehicle data” above) may be recorded and logged in the data store 254 (It is noted that broadly speaking the data breaks down into sensor data that provides information about the state of the vehicle and sensor data that can be used to infer the type of environment the vehicle is driving through):

Vehicle Data Related to Vehicle State

Front Right wheel speed

Front Left wheel speed

Rear Right wheel speed

Rear Left wheel speed

Steering angle

Front Right ride height

Front Left ride height

Rear Right ride height

Rear Left ride height

vehicle lateral acceleration

vehicle longitudinal acceleration

vehicle yaw rate/acceleration

differential lock status

differential locking torque

damper stiffness

engine revs

gear position

Tyre pressure

Terrain Response—user selected terrain mode (e.g. mud and ruts, grass, gravel, snow, sand, rock etc.) or system terrain recommendation Sensor output from Parking Distance Control (PDC) sensors

Vehicle Data Related to Environment

Vehicle ground speed

terrain type

terrain roll

terrain pitch

vehicle yaw angle

vehicle Roll angle

vehicle Pitch angle

Direction of travel (e.g. forward or backward direction of travel)

Compass bearing

Latitude of vehicle

Longitude of vehicle

altitude of vehicle (height above sea level)

Video feed from vehicle camera(s)

Audio feed from vehicle microphone(s)

Distance to obstacles in environment

It is noted that the following vehicle sub-systems will utilise some or all of the above sensor outputs.

Terrain Response; Active Dynamics (uses wheel speeds, lateral & longitudinal acceleration & yaw acceleration, damper stiffness); Electronic cross linked air suspension with variable ride height (uses Front Right ride height, Front Left ride height, Rear Right ride height, Rear Left ride height); Hill Descent Control (uses wheel speeds, vehicle speed, brake pressure (each wheel), engine speed); Active/Passive rear and centre diff (diff lock status, diff locking torque, engine torque output); Torque Vectoring by Braking (uses individual wheel speeds, wheel brake pressures, yaw rate, steering angle, vehicle speed); Active Dynamics/Continuously Variable Damping (CVD) (wheel speeds, lateral & longitudinal acceleration & yaw acceleration, damper stiffness); Active Exhaust; Launch Mode (uses Engine revs, gear position, engine torque out, longitudinal acceleration, vehicle speed, wheel speeds); E-diff (electronic Differential) (uses diff locking torque, engine torque output); Active Driveline (uses differential lock status, wheel speeds, lateral & longitudinal acceleration & yaw acceleration, damper stiffness; Wade sensing (uses PDC data, vehicle camera data); Tyre Pressure Monitoring System (TPMS) (uses vehicle tyre pressures).

The system and method of the present invention may therefore collect one, some or all of the above noted vehicle data sensor outputs for use in generating an animation of the vehicle. It is also noted that the sensor data related to the environment that the vehicle is travelling through may be used to reconstruct a representation of the road surface and direction and/or the terrain that the vehicle is travelling over.

The terrain type over which the vehicle has travelled may be determined in dependence on a selected Terrain Response mode. The Terrain Response mode may comprise one of a grass, gravel, snow mode (GGS), a mud and ruts mode (M+R), a rock crawl mode (RC), or special programs off (SPO). Thus, in embodiments of the invention, the appearance of the animated terrain may be selected in accordance with the Terrain Response.

The animated terrain may be generated in dependence on, for example, the selected vehicle ride height or actual measured suspension travel of each wheel, optionally in conjunction with inclinometer and/or accelerometer measurements. For example, the animated terrain over which the vehicle travels may be angled in dependence on an inclinometer measurement and/or represent an obstacle, such as a rock or boulder, over which the vehicle is travelling in dependence on the inclination or attitude of the vehicle cabin and any relative differences between measured suspension travel at the respective wheels.

In addition to the above sensor outputs the system and method of the present invention may capture video data from on-board camera systems (e.g. parking assist cameras) and audio data from microphones on the vehicle.

The video data may be used in constructing the animation and the audio data may be used to generate a realistic and representative power train sound for use in the animation.

In a particular example of the use of video footage, forward facing video cameras may capture images of a vehicle's surroundings as a journey is made. The animation of the vehicle journey that is subsequently generated may comprise generating an animation of the vehicle and overlaying the vehicle animation onto the captured footage. A “behind the vehicle” point of view may then be provided to a user watching the animation of the vehicle journey. The video footage may also be processed to sample the colours of the vehicle's surroundings. In an embodiment of the invention, the generated animation comprises an animated environment through which the vehicle travels and the animated environment is generated at least in part in dependence on the sampled colours. The animated environment may be combined with video footage to create a composite environment in which the animated vehicle is displayed.

In a further aspect of the invention the vehicle data received from the various on-board and external sensors may be used to determine faults in a vehicle sub-system, e.g. an ABS system or other safety or driving system.

In this aspect of the invention vehicle data received from the one or more vehicle sensors may additionally be checked against sections of the journey that conform to predetermined driving parameters to identify any faults in vehicle sub-systems. For example, excessive braking conditions would be expected to result in the activation of an ABS system. Vehicle data from an accelerometer could be analysed to determine sections of the journey which should have triggered the ABS system. An ABS activation log may then be cross checked with the analysed vehicle data to determine if it activated as expected, an error flag being raised in the event that the vehicle sub-system did not activate correctly.

Conveniently, for sections of the journey that conform to predetermined driving parameters, the method may further comprise: checking if a given section comprises vehicle driving parameters that would trigger a vehicle safety system; checking the identified vehicle safety system during the time period associated with the given section; identifying a fault condition if the identified vehicle safety system was not active during the given section.

In the embodiment discussed above in relation to FIGS. 2 to 6 the user interacts with the system via a web portal and associated server computers. In an alternative embodiment the vehicle data may be processed by a user device, e.g. a smartphone or tablet computer or user computer. In such an embodiment the logged raw data in data store 254 may be transferred to the user's device rather than a web server. Data processing, animation rendering etc. may then occur locally.

In a yet further embodiment the raw data may be processed on board the vehicle and presented to the user via a vehicle based infotainment system.

1. A method of representing a vehicle journey to a user, the method comprising:
recording vehicle data over time for the vehicle journey, the recorded vehicle data comprising video footage of the vehicle's surroundings during the vehicle journey;
processing the recorded vehicle data in order to generate an animation of the vehicle journey, the animation of the vehicle journey comprising an animated representation of the vehicle combined with the recorded video footage; and
displaying at least part of the generated animation to the user.

2. The method of claim 1, wherein the vehicle data is recorded from one or more vehicle sensors.

3. The method of claim 1, wherein the vehicle data is supplied from a vehicle communication network.

4. The method of claim 3, wherein the vehicle communication network comprises one of a controller area network (CAN) bus, Flexray bus or Ethernet bus.

5. The method of claim 2, wherein sensor outputs from the one or more vehicle sensors comprise one or more of the following: front right wheel speed; front left wheel speed; rear right wheel speed; rear left wheel speed; steering angle; front right ride height; front left ride height; rear right ride height; rear left ride height; vehicle lateral acceleration; vehicle longitudinal acceleration; vehicle yaw rate/acceleration; differential lock status; differential locking torque; damper stiffness; engine revs; gear position; vehicle ground speed; terrain type; terrain roll; terrain pitch; vehicle yaw angle; vehicle roll angle; vehicle pitch angle; direction of travel; latitude of vehicle; longitude of vehicle; altitude of vehicle (height above sea level); terrain response selection or system recommendation; output from parking distance control sensor; tyre pressure; compass bearing; video feed; and audio feed.

6-14. (canceled)

15. The method of claim 1, wherein the vehicle data is supplied from an external sensor.

16. The method of claim 15, wherein the vehicle data is supplied from a mobile communications device comprising the external sensor.

17. The method of claim 16, wherein the mobile communications device comprises a smartphone running a software app, wherein the smartphone is in communication with a vehicle electronic control unit via a communications link.

18. (canceled)

19. The method of claim 1, wherein the animation provides a virtual point of view option allowing the animation to be replayed from any desired viewpoint.

20-25. (canceled)

26. The method of claim 1, wherein the vehicle data is recorded for a complete vehicle journey between ignition events.

27. The method of claim 1, wherein the vehicle data is recorded for part of the vehicle journey occurring between ignition events.

28. The method of claim 26, wherein vehicle data is recorded in response to a user activated control signal.

29-31. (canceled)

32. A system for representing a vehicle journey to a user, the system comprising:
at least one sensor that records vehicle data over time for the vehicle journey, the recorded vehicle data comprising video footage of the vehicle's surroundings during the vehicle journey; and
a processor that processes the recorded vehicle data in order to generate an animation of the vehicle journey, the animation of the vehicle journey comprising an animated representation of the vehicle combined with the recorded video footage.

33. The system of claim 32, further comprising an interface that displays at least part of the generated animation to the user.

34. A vehicle, comprising a system for representing a vehicle journey to a user, the system comprising:
at least one sensor that records vehicle data over time for the vehicle journey, the recorded vehicle data comprising video footage of the vehicle's surroundings during the vehicle journey; and
a processor that processes the recorded vehicle data in order to generate an animation of the vehicle journey, the animation of the vehicle journey comprising an animated representation of the vehicle combined with the recorded video footage.

35. (canceled)
